(19) United States
(12) Patent Application Publication
(10) Pub. No.: US 2004/0218066 A1
(43) Pub. Date: Nov. 4, 2004

(54) Stopwatch function between exposures in a digital imaging device

(76) Inventors: Heather Noel Bean, Fort Collins, CO (US); Mark Nelson Robins, Greeley, CO (US)

Correspondence Address: HEWLETT-PACKARD COMPANY, Intellectual Property Administration, P.O. Box 272400, Fort Collins, CO, 80527-2400, US

(21) Appl. No.: 09/878,519

(22) Filed: Jun. 11, 2001

(51) Int. Cl. H04N 5/76; H04N 5/91

(52) U.S. Cl. 348/231.99

(57) ABSTRACT

An elapsed time apparatus and method are provided according to one embodiment of the invention. The elapsed time apparatus and method are capable of adding an elapsed time to a digital image generated by a digital image capturing device. The elapsed time apparatus comprises a counter capable of measuring an elapsed time between a first image capture and a second image capture. The elapsed time apparatus further comprises a memory that is capable of storing a plurality of digital images and is capable of storing at least one elapsed time value. The elapsed time apparatus further comprises a processor communicating with the counter and the memory. The processor obtains an elapsed time value from the counter upon the second image capture and adds the elapsed time value to a second digital image captured during the second image capture.

### FIELD OF THE INVENTION

The present invention relates generally to a time stamp function in an image capturing device, and more particularly to an elapsed time stamp function in an image capturing device.

### BACKGROUND OF THE INVENTION

Image capturing devices are used to visually memorialize scenes, events, or items. A common image capturing device is a camera. Cameras include both still and video cameras, and increasingly employ digital technology to capture images. They commonly use a lens apparatus to admit light reflected from the image of interest and focus it onto an electronic image capturing apparatus, such as a CCD array or a CMOS array, for example. In addition, most modern cameras include a processor and/or other control electronics that function to control shutter speed, aperture, flash, focus, etc. A camera may also include one or more user input devices that allow a user to turn the camera on and off, select settings, capture images, select flashes, zoom in or out, etc.

A prior art digital image capturing device may be used to capture many types of images, including sequential images, such as images of historical events, sporting events, laboratory experiments, time-lapse photography, etc. In the prior art, the labeling or stamping of such images is typically done with a time stamp that may give a day, month and year, such as for example, Jan. 1, 2000. A prior art image capturing device may even include an instantaneous time, such as 10:00 AM, for example.

However, the prior art digital image capturing device does not include an elapsed time stamp denoting an elapsed time between images. This feature may be important for several reasons. The user may desire a stopwatch function between images in a sequence. An elapsed time/stopwatch functionality may be desired by the user when capturing sequential images or when capturing any chronologically closely-spaced images. Furthermore, an elapsed time stamp would aid the user in easily or reliably determining an image sequence. Unless the prior art digital camera has a very high resolution time stamp, the user may not be able to tell the order of the sequential images.

Therefore, there remains a need in the art for improvements in image capturing devices.

### SUMMARY OF THE INVENTION

An elapsed time apparatus is provided according to one embodiment of the invention. The elapsed time apparatus is capable of adding an elapsed time to a digital image generated by a digital image capturing device. The elapsed time apparatus comprises a counter capable of measuring an elapsed time between a first image capture and a second image capture. The elapsed time apparatus further comprises a memory that is capable of storing a plurality of digital images and is capable of storing at least one elapsed time value. The elapsed time apparatus further comprises a processor communicating with the counter and the memory. The processor obtains an elapsed time value from the counter upon the second image capture and adds the elapsed time value to a second digital image captured during the second image capture.

According to another embodiment of the invention, the elapsed time apparatus comprises an elapsed time counter capable of being reset upon a first image capture. The elapsed time apparatus further comprises a memory that is capable of storing a plurality of digital images and is capable of storing at least one elapsed time value. The elapsed time apparatus further comprises a processor communicating with the counter and the memory. The processor starts the elapsed time counter upon the first image capture, reads an elapsed time value from the elapsed time counter upon a second image capture, and adds the elapsed time value to a second digital image captured during the second image capture.

According to another embodiment of the invention, a computer-implemented elapsed time generation method for a digital image capturing device is provided. The method comprises the step of generating an elapsed time value of an elapsed time between a first image capture and a second image capture in the digital image capturing device. The method further comprises the step of adding the elapsed time value to the digital image captured at the second image capture time.

### BRIEF DESCRIPTION OF THE DRAWINGS

FIG. 1 is a block diagram of a digital image capturing device according to one embodiment of the invention; and

FIG. 2 is a flow chart of a computer-implemented elapsed time generation method according to another embodiment of the invention.

### DETAILED DESCRIPTION

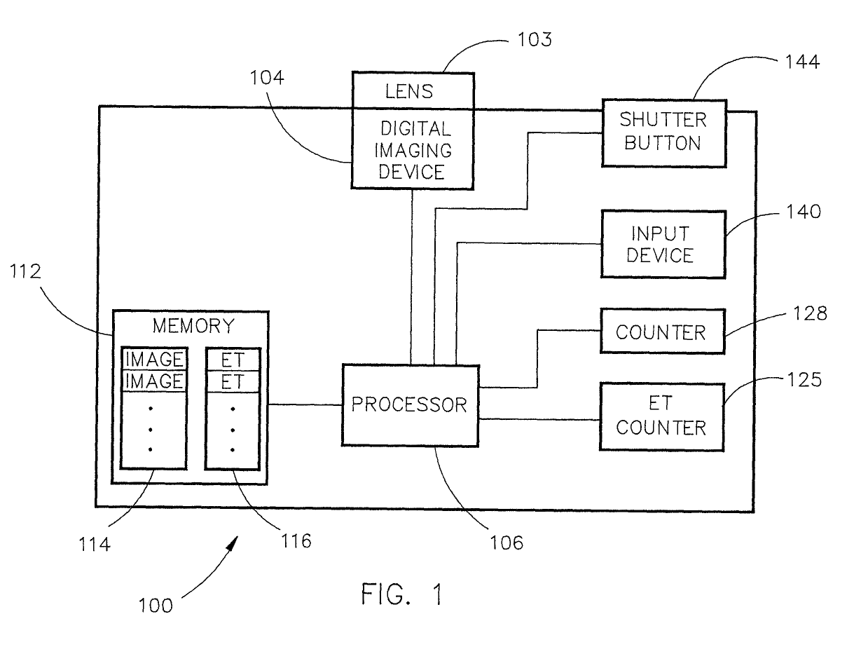

FIG. 1 is a block diagram of a digital image capturing device 100 according to one embodiment of the invention. The digital image capturing device 100 includes a lens 103, an electronic imaging device 104, a processor 106, a memory 112, a counter 128, an elapsed time counter 125, at least one input device 140, and a shutter button 144.

The electronic imaging device 104 may be any type of electronic imaging device, including a CCD array or CMOS array, for example. The electronic imaging device 104 outputs a plurality of image signals, which may be analog image signals or digital image signals. The plurality of image signals are communicated to the processor 106.

The processor 106 may be any type of general purpose processor. The processor 106 communicates with the electronic imaging device 104, the memory 112, the elapsed time counter 125, the counter 128, the input device 140, and the shutter button 144. The processor 106 may control the overall operation of the digital image capturing device 100, and controls storage and handling of the captured images. If the captured images are received as a plurality of analog image signals, they are digitized by the processor 106 or by other associated circuitry (not shown). The processor 106 further controls the generation and storage of an elapsed time stamp.

The memory 112 may be any type of memory, including all types of random access memory (RAM), read-only memory (ROM), magnetic storage media such as magnetic disc, tape, etc., or optical or bubble memory. The memory 112 may include, among other things, an image storage section 114 for storing a plurality of digital images and may optionally include an elapsed time storage section 116 for storing one or more elapsed time values. The memory 112 may also store a calendar for maintaining day, month, and year information. In addition, the memory 112 may store software programs to be executed by the processor 106.

The counter 128 may be any type of digital counter that provides some manner of time signal to the processor. In a typical application, the counter 128 may be a shift register that clocks time-representative bits and relays them to the processor 106, which may use them to determine time. For example, the counter may be a shift register that is incremented on a millisecond or microsecond basis and can track seconds, minutes, hours, days, etc.

The elapsed time counter 125 may be a specialized counter that may be started and stopped by the processor 106 in order to measure an elapsed time between image captures. For example, the elapsed time counter 125 may be started and stopped with each consecutive press of the shutter button 144. The elapsed time counter 125 is started by being cleared and allowed to run, therefore counting an elapsed time from when it was cleared. Alternately, the elapsed time counter 125 may determine the elapsed time between a first image capture and each of a plurality of subsequent image captures. For example, the elapsed time counter 125 could be started with the first image capture and continue to run, while sending elapsed time information to the processor 106 upon each subsequent image capture.

It should be understood that the counter 128 and the elapsed time counter 125 may be independent devices, as shown. Alternatively, they may be integral portions of the processor 106.

The input device 140 may be any type of user input device, such as a button, a switch, etc. The input device 140 may include a user interface that contains a touch screen input, for example. The input device 140 may be used to select an elapsed time mode, and additionally may be used to add or remove elapsed time values from selected images stored in the memory 112.

The shutter button 144 may be employed to initiate an image capture. The shutter button 144 is preferably connected to the processor 106, which receives and stores an image from the electronic imaging device 104 when the shutter button 144 is pressed. The captured digital image may be stored in the image storage section 114 of the memory 112. In addition, when the shutter button 144 is pressed, the processor 106 may use the counter 128 or the elapsed time counter 125 to generate an elapsed time value and to store the elapsed time value in the memory 112. The elapsed time value may be stored in the image storage section 114, or alternatively may be stored separately in an elapsed time storage section 116 (discussed below).

The digital imaging device 100 may be employed in one of several elapsed time modes. In a first elapsed time mode, an elapsed time value is automatically generated if the digital imaging device 100 is put into an elapsed time mode by the user. As a result, the processor 106 generates an elapsed time value for each image taken. The elapsed time value may be stored in the elapsed time storage section 116, but is preferably stored within the image file in the image storage section 114. If stored within the captured image, the elapsed time value is stored as a graphical representation of the elapsed time, and is inserted directly into the image in the image storage section 114. This may be accomplished by modifying appropriate digital values in the memory 112.

In a second elapsed time mode, an elapsed time value is generated and stored for every captured image. The elapsed time value is stored in the elapsed time storage section 116. At any time after the image capture, the user may select an individual elapsed time value and associate it with the corresponding image in the image storage section 114. Alternatively, when the user selects the elapsed time value, it may be copied from the elapsed time value storage section 116 and directly inserted into the captured image, as previously discussed.

From the first mode, the user may select the elapsed time mode and may capture a sequence of images and then de-select the elapsed time mode. As a result, all of the images taken in the elapsed time mode include an elapsed time. Alternatively, in the second mode, the user may capture images and may later add elapsed time value if desired, such as before printing or transferring a captured image.

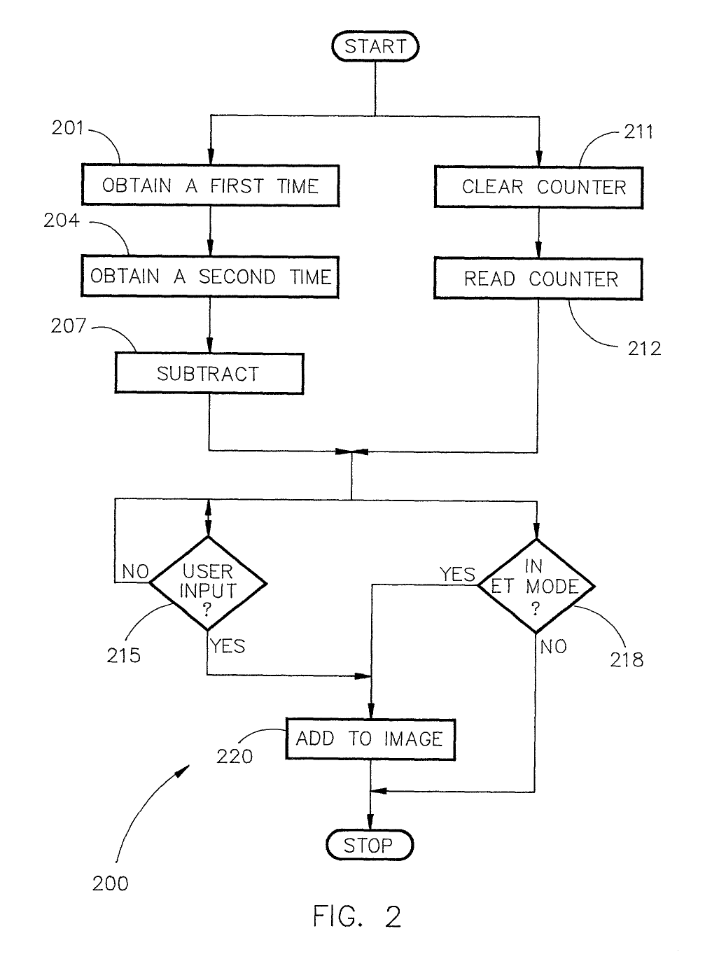

FIG. 2 is a flow chart 200 of a computer-implemented elapsed time generation method according to another embodiment of the invention. The elapsed time value may be generated according to two method paths. In the first path, in step 201, a first image capture time is obtained during a first image capture. In step 204, a second image capture time is obtained during a second image capture. In step 207, the second image capture time is subtracted from the first image capture time to generate the elapsed time value.

In the second method path, in step 211, a free-running elapsed time a counter is cleared or reset. In step 212, the elapsed time counter is read in order to generate the elapsed time value.

The elapsed time value may be used according to another two method paths. In the first path, in step 215, a user elapsed time input is detected. If a user elapsed time input is detected, the method proceeds to step 220, else it waits for a user elapsed time input.

In the second usage path, in step 218, if the electronic imaging device is in an elapsed time mode, the method proceeds to step 220, else it skips step 220.

In step 220, the elapsed time value is added to the captured image. This may occur at the time of image capture, when the elapsed time value is calculated, as in step 218. If the electronic imaging device is in the elapsed time mode, an elapsed time value is obtained and stored for each capture digital image.

Alternatively, the elapsed time value may be later added to the captured image, as in step 215. This may include the steps of storing an elapsed time value, accepting a user input that selects an elapsed time value addition to the captured digital image, and adding the elapsed time value to the digital image. The adding step may store the elapsed time value in an elapsed time storage associated with the digital image, or may overwrite the elapsed time value onto a portion of the stored digital image.

We claim:

1. An elapsed time apparatus capable of adding an elapsed time to a digital image generated by a digital image capturing device, comprising:
a counter capable of measuring an elapsed time between a first image capture and a second image capture;
a memory capable of storing a plurality of digital images and further capable of storing at least one elapsed time value; and
a processor communicating with said counter and said memory and obtaining an elapsed time value from said counter upon said second image capture, and adding said elapsed time value to a second digital image captured during said second image capture.

2. The elapsed time apparatus of claim 1, wherein said counter generates a first image capture time and a second image capture time, and wherein said processor subtracts said first image capture time from said second image capture time to produce said elapsed time value.

3. The elapsed time apparatus of claim 1, wherein said processor starts said counter upon capture of a first digital image and reads an elapsed time value from said counter upon capture of said second digital image.

4. The elapsed time apparatus of claim 1, further comprising at least one input device capable of accepting a user input that selects or de-selects an elapsed time mode, and wherein said memory stores an elapsed time value for each digital image captured during said elapsed time mode.

5. The elapsed time apparatus of claim 1, further comprising at least one input device capable of accepting a user input that selects and adds a particular elapsed time value to a corresponding stored digital image.

6. The elapsed time apparatus of claim 1, wherein said memory stores said elapsed time value in an elapsed time storage associated with said digital image.

7. The elapsed time apparatus of claim 1, wherein said digital image is stored in an image storage and said adding step overwrites said elapsed time value onto a portion of said digital image stored in said image storage.

8. An elapsed time apparatus capable of adding an elapsed time to a digital image generated by a digital image capturing device, comprising:
an elapsed time counter capable of being reset upon a first image capture;
a memory capable of storing a plurality of digital images and further capable of storing at least one elapsed time value; and
a processor communicating with said counter and said memory and starting said elapsed time counter upon said first image capture, reading an elapsed time value from said elapsed time counter upon a second image capture, and adding said elapsed time value to a second digital image captured during said second image capture.

9. The elapsed time apparatus of claim 8, further comprising at least one input device capable of accepting a user input that selects or de-selects an elapsed time mode, and wherein said memory stores an elapsed time value for each digital image captured during said elapsed time mode.

10. The elapsed time apparatus of claim 8, further comprising at least one input device capable of accepting a user input that selects and adds a particular elapsed time value to a corresponding stored digital image.

11. The elapsed time apparatus of claim 8, where in said memory stores said elapsed time value in an elapsed time storage associated with said digital image.

12. The elapsed time apparatus of claim 8, wherein said digital image is stored in an image storage and said adding step overwrites said elapsed time value onto a portion of said digital image stored in said image storage.

13. A computer-implemented elapsed time generation method for a digital image capturing device, comprising the steps of:
generating an elapsed time value in a counter of an elapsed time between a first image capture and a second image capture in said digital image capturing device; and
adding said elapsed time value to said digital image captured at said second image capture time.

14. The computer-implemented method of claim 13, wherein the generating step further comprises the steps of:
generating a first image capture time generated by said counter upon said first image capture;
generating a second image capture time generated by said counter upon said second image capture; and
subtracting said first image capture time from said second image capture time to produce said elapsed time value.

15. The computer-implemented method of claim 13, wherein the generating step further comprises the steps of:
resetting said counter upon said first image capture; and
reading said elapsed time value from said counter upon said second image capture.

16. The computer-implemented method of claim 13, further comprising the step of accepting a user input that selects or de-selects an elapsed time mode, with an elapsed time value being generated for each digital image captured during said elapsed time mode.

17. The computer-implemented method of claim 13, further comprising the step of accepting a user input that controls said adding of said elapsed time value to said digital image.

18. The computer-implemented method of claim 13, wherein said adding step further comprises the steps of:
storing said elapsed time value;
accepting a user input that selects an elapsed time value addition for said digital image; and
adding said elapsed time value to said digital image.

19. The computer-implemented method of claim 13, wherein said adding step stores said elapsed time value in an elapsed time storage associated with said digital image.

20. The computer-implemented method of claim 13, wherein said digital image is stored in an image storage and said adding step overwrites said elapsed time value onto a portion of said digital image.
